(19) United States
(12) Patent Application Publication
(10) Pub. No.: US 2006/0210011 A1
(43) Pub. Date: Sep. 21, 2006

(54) High temperature gas-cooled fast reactor

(76) Inventor: Ratib A. Karam, Stone Mountain, GA (US)

Correspondence Address: Kenneth W. Float, 2095 Hwy. 211 NW, # 2F, Braselton, GA, 30517, US

(21) Appl. No.: 11/286,109

(22) Filed: Nov. 23, 2005

Related U.S. Application Data
(60) Provisional application No. 60/662,264, filed on Mar. 16, 2005.

(51) Int. Cl. G21C 1/04

(52) U.S. Cl. 376/347

(57) ABSTRACT

Fast reactors are disclosed that embody a central core surrounded by a reflector that each comprise a plurality of abutting hexagonal blocks of ceramic material. Each hexagonal block comprises a plurality of coolant channels disposed therethrough. Outer surfaces of each hexagonal block and surfaces of each coolant channel are coated with a material defining a containment shell. Burnable poison is disposed in the central core. The central core may comprise a graphite foam and uranium carbide matrix or uranium carbide. The containment shell may comprise silicon carbide or a carbon-carbon composite material. The reflector comprises natural uranium. Exemplary reactors operate at about 1000° C. and at a pressure of 68 bars (1000 psi) in a direct gas cycle at an efficiency of approximately 50%. Exemplary reactors also require no fuel addition or removal for more than 50 years.

### BACKGROUND

The present invention relates generally to reactors, and more particularly to high temperature gas-cooled fast reactors.

In a paper by R. A. Karam, Dwayne Blaylock, Eric Burgett, S. Mostafa Ghiaasiaan, Nolan Hertel, and Cassiano R. E. deOliveira, entitled “High Temperature Gas-Cooled Fast Reactor,” delivered at the 2005 International Congress on Advances in Nuclear Power Plants, May 15-19, 2005, Seoul, Korea, it was reported that a very high temperature (1000° C.) helium-cooled fast reactor using uranium carbide (12% enrichment) embedded in a graphite foam that has a density of 0.5 g/cm³ and encapsulated with a 50 μm silicon carbide (SiC) shell, operating at 1000 psi (68 Bar) pressure in a direct cycle mode and producing 1000 MWE of power was feasible. It was also reported in this paper that the reactor can operate 10 years continuously with no need for refueling.

It would be desirable to improve the reactor designs presented in this paper. For instance, it would be desirable to decrease the foam density in the reactor and to increase the operational fuel cycle. It would also be desirable to improve other aspects of the reactor described in this paper.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates an exemplary hexagonal building block used in constructing core and blanket assemblies of exemplary fast reactors;

FIG. 2 illustrates an exemplary high temperature helium-cooled fast reactor having burnable poison in a central core region;

FIG. 3 illustrates an exemplary reactor having burnable poison in central and outer regions of the central core region;

FIG. 4 is a graph that illustrates a neutron spectrum at the center of the cores of the reactors shown in FIGS. 2 and 3;

FIG. 5 is a graph that illustrates Doppler coefficients for uranium carbide in foam at various times in fuel depletion calculation;

FIG. 6 is a graph that illustrates Doppler reactivity changes for the reactor shown in FIG. 2 from a 1000° C. base obtained with SCALE and MCNP5 calculations at various times in the fuel cycle;

FIG. 7 is a graph that illustrates Doppler reactivity changes for the reactor shown in FIG. 3 from a 1000° C. base obtained at zero and 25 years in the fuel cycle;

FIG. 8 is a graph that illustrates Doppler coefficient for the reactor shown in FIG. 3 at various times in the fuel depletion calculations;

FIG. 9 is a graph that illustrates K_{eff} as a function of year of operation for the reactors shown in FIGS. 2 and 3;

FIG. 10 is a graph that illustrates loss of pressure coefficient as a function of pressure for both options from SCALE and MCNP5.

### DETAILED DESCRIPTION

Under the gas-cooled fast reactor component of the Generation IV Nuclear Energy Systems Initiative, the present inventors have conducted scoping calculations for a very high temperature (1000° C.) helium-cooled fast reactor 10 (FIGS. 2 and 3). Based upon these scoping calculations, three distinct embodiments of the fast reactor 10 have been developed.

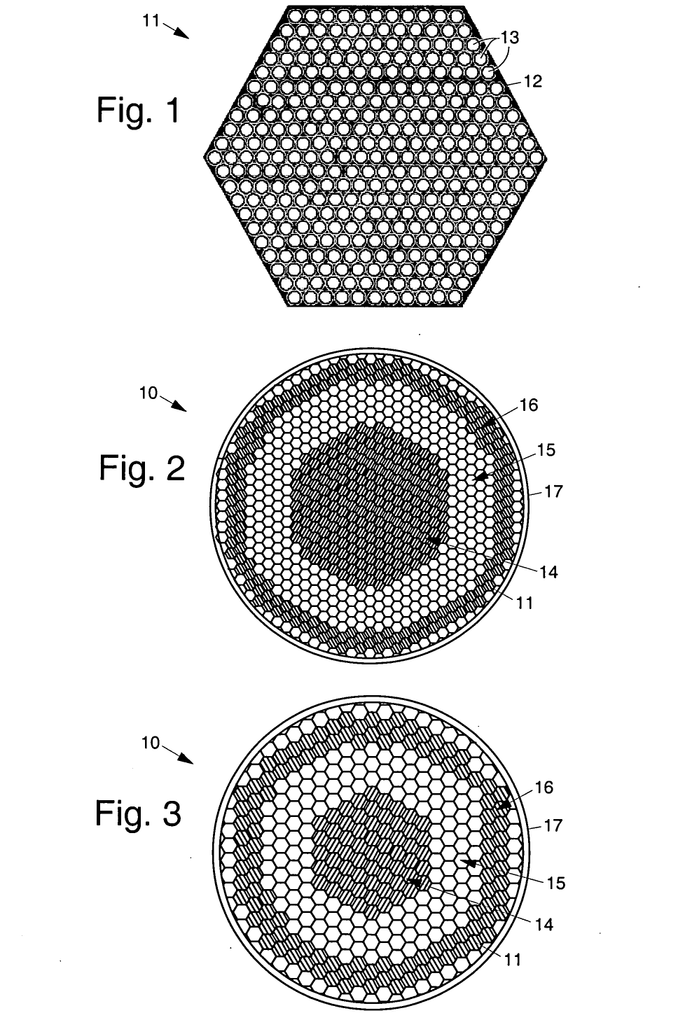

Referring to the drawing figures, FIG. 1 illustrates an exemplary hexagonal block 11 that is used to fabricate the fast reactor 10. Assemblies of these hexagonal blocks 11 are constructed to fabricate the three embodiments of the fast reactor 10. Exemplary fast reactors 10 are illustrated in FIGS. 2 and 3.

The first embodiment of the fast reactor 10 uses hexagonal building blocks 11 comprising graphite foam into which ceramic material such as uranium carbide (12% enrichment) is embedded into a matrix, and each block 11 of graphite foam is encapsulated with silicon carbide as a containment shell 12. The second embodiment of the fast reactor 10 uses hexagonal blocks 11 comprising ceramic material such as uranium carbide (12% enrichment) molded into the same shape and size as the graphite foam-uranium carbide matrix in the first embodiment, and each hexagonal block 11 of uranium carbide is encapsulated with silicon carbide as a containment shell 12. The third embodiment of the fast reactor 10 uses hexagonal blocks 11 of ceramic material such as uranium carbide molded into the same shape and size as the graphite foam-uranium carbide matrix in the first embodiment, and each block 11 of uranium carbide is encapsulated with carbon-carbon composite as a containment shell 12. The uranium carbide may be molded into a hexagonal shape using relatively low pressure and heat. Each hexagonal block 11 has a plurality of cooling channels 13 formed therethrough that are generally aligned parallel to outer surfaces of the hexagonal blocks 11.

Exemplary graphite foam for use in the reactor 10 has been developed at Oak Ridge National Laboratory (ORNL), and may be manufactured to a specified density as requested by a user. The range may be varied between 0.25 to 0.65 g/cm³. Experiments at ORNL indicate that particles such as uranium carbide can be loaded into the foam to occupy as much as 75 percent of the voids in the foam. The voided space within the foam ranges from 87.5 to 67.5 percent, assuming solid graphite has a density of 2.0 g/cm³. The thermal conductivity of the foam is excellent (˜100 W/m° k). Additional details regarding the foam may be found in a report by G. T. Mays, F. C. Difillippo, N. C. Gallego, J. W. Kleff, P. J. Otaduy, and R. T. Primm, III, “Solid State Reactor Final Report, Draft Report, ORNL, 1996.

Referring to FIG. 2, it illustrates a preferred design for the first embodiment of the reactor 10 containing graphite foam. FIG. 3 illustrates preferred designs for the second and third embodiments of the reactor 10.

As is shown in FIGS. 2 and 3, a plurality of hexagonal building blocks 11 are used to fabricate central and outer cores 14, 15 and a blanket or reflector 16 of all embodiments of the exemplary reactors 10. An outer housing 17, which may be made of steel, surrounds the central and outer cores 14, 15 and reflector 16. In the reflector 16, natural (unenriched) uranium is used. Each hexagonal block 11 is preferably coated with a 50 μm thick layer of either silicon carbide composite (first and second embodiments) or carbon-carbon composite (third embodiment) on all surfaces to provide the containment shell 12. The 50 μm containment shell 12 is used to contain fission products. No metallic material is used in the core 14.

The third embodiment of the reactor 10 uses carbon-carbon composite as the containment shell 12. The uranium carbide material and geometrical configuration of the hexagonal blocks 11 used to fabricate the third embodiment of the reactor 10 is the same as the second embodiment, and the carbon-carbon composite shell 12 is used. Carbon-carbon composite material is strong, has thermal conductivity comparable to aluminum, remains strong at temperatures of 2500° C., and has desirable nuclear characteristics in that it produces a slightly harder neutron spectrum.

Referring again to FIG. 1, the basic element of the core 14, 15 and blanket 16 is the hexagonal block 11, which may be approximately 24 cm. flat-to-flat distance, containing 10 rings of cooling channels 13, for example. In a preferred embodiment, each channel 13 is one centimeter in diameter, and channel-to-channel pitch is 1.3 cm.

The first embodiment of the reactor 10 preferably uses graphite foam whose density is lowered from 0.5 g/cc to 0.3 g/cc, and has two core regions 14, 15 (central and outer) and one reflector region 16. All three regions 14, 15, 16 comprise the hexagonal blocks 11 shown in FIG. 1, and are stacked together radially and axially to form nearly a right cylinder. In the first embodiment of the reactor 10, the hexagonal blocks 11 of the reflector 14, 15 contain natural uranium carbide embedded in graphite foam. The two core regions 14, 15 contain 12% enriched uranium carbide in the same graphite foam. The enrichment in both core regions 14, 15 is the same. The only difference is that the central region 14 contains a burnable poison, B-10, in a concentration of 4.1×10⁻⁴ atoms/b-cm.

In a preferred embodiment, the outer radius of the central region 14 is 180 cm. and the outer radius of the outer core region 15 is 280 cm, the outer radius of the reflector 16 is 325 cm, the physical height of the core 14, 15 is 600 cm, and the thickness of the axial reflector 16 is 30 cm. Reactor power for the first embodiment of the reactor 10 is 2500 MWth. Helium coolant velocity is 22.95 m/s. Core power density is 17 Kw/liter. All hexagonal blocks 11 of the core 14, 15 and blanket 16 are encased with a 50 μm silicon carbide shell 12. The cooling channels 13 are also coated with 50 μm silicon carbide layer, which comprises part of the shell 12.

The second embodiment of the reactor 10 uses only uranium carbide molded into the hexagonal blocks 11 (i.e., no graphite foam) which may be molded using compression and sintering. The blocks 11 for the reflector 16 are made with natural uranium carbide and the blocks 11 for the core 14, 15 are made with 12% enriched uranium carbide. In an exemplary embodiment, the outer radius of the central core 14 is 96.95 cm., the outer radius of the outer core 15 is 175.11 cm., and the outer radius of the reflector 16 is 219.61 cm. The height of the core 14, 15 is 427.68 cm. The axial thickness of the reflector 16 is 30 cm. The concentration of B-10 poison in the central core 14 is 5.0×10⁻⁴ atoms/b-cm. The concentration of B-10 poison in the outer core 15 is 2.9×10⁻⁴ atoms/b-cm. The reactor power is 2500 MWth. The coolant helium velocity=99.42 m/sec. Power density in the core 14, 15 is 60.67 Kw/liter. Each hexagonal block 11 is encased with a 50 μm shell 12 comprising silicon carbide.

The third embodiment of the reactor 10 has the same dimensions and layout as the second embodiment. Only the silicon carbide shell 12 is changed to carbon-carbon composite material. The carbon-carbon composite has a density of 1.7 g/cc. The reactor 10 is 2500 MWth and the power density was similar to the second embodiment of the reactor 10.

The mechanics for evaluating thermal hydraulic performance of the reactors 10 is discussed in the “High Temperature Gas-Cooled Fast Reactor” paper. Conservative values for thermal conductivity and heat transfer coefficients were used. Helium gas inlet and outlet temperatures were set at 700° C. and 1000° C. respectively. Helium pressure was set at 1000 psi (68 bars). Based on these parameters, the maximum temperature in the hexagonal block 11 occurred at the top of the core 14, 15, and was 1066° C.

The three embodiments of the reactor 10 were analyzed using two parallel paths: one set of calculations used a “SCALE” system of codes discussed in NUREG/CR-0200 Rev. 6, ORNUNUREG/CSD-2/R6, March 2000. Specifically NITAWL-II was used to generate resonance-shielded cross-sections (238 groups) for use in a one dimensional transport code XSDRNPM. The XSDRNPM code is also a component of the SCALE system. ENDF/BV cross-sections were used to generate the 238 groups. The quadrature used with the SN code was N=32.

The flux generated with the transport code were then used with the code ORIGEN-S to determine the quantity of fission product generated each year as well as the depletion and build-up of core constituents. Also K_{eff} for each core was calculated every year using XSDRNPM for a 25-year period for the first embodiment of the reactor 10 and a 50-year period for the second embodiment of the reactor 10, and 55-year period for the third embodiment of the reactor 10.

In order to validate the results obtained using the SCALE system of codes, the three embodiments of the reactor 10 were analyzed using the three-dimensional Monte Carlo code MCNP5 with point-to-point dependence in energy as well as in space and simulating the as-built cores 14, 15 and blankets 16. In these calculations, the K_{eff} obtained using ENDF/BV and ENDF/B-VI cross-sections were compared with the results obtained from the SCALE system of codes. Doppler coefficients and loss of coolant pressure were also compared. Small differences in K_{eff} were observed between ENDF/B-V and ENDF/B-VI cross-sections as well as differences between results from the SCALE system of codes and MCNP5. These differences are on the order of 1% in K_{eff} and reported in detail in the “High Temperature Gas-Cooled Fast Reactor” paper. The code NJOY-99.90 was used to generate temperature broadened cross-sections for use in conjunction with MCNP5 to obtain Doppler coefficients.

Since K_{eff} at the beginning of life for the three embodiments of the reactor 10 was approximately 1.10, burnable B-10 poison was included in the central core 14 only of the first embodiment of the reactor 10, and in both the central and outer core regions 14, 15 for the second and third embodiments of the reactor 10. The addition of B-10 poison lowered the value of K_{eff} at the beginning of life to nearly 1.0. As the reactor 10 is operated year after year, the B-10 poison depletes and the concentration of fission products increases. The results for all three embodiments of the reactor 10 are discussed below.

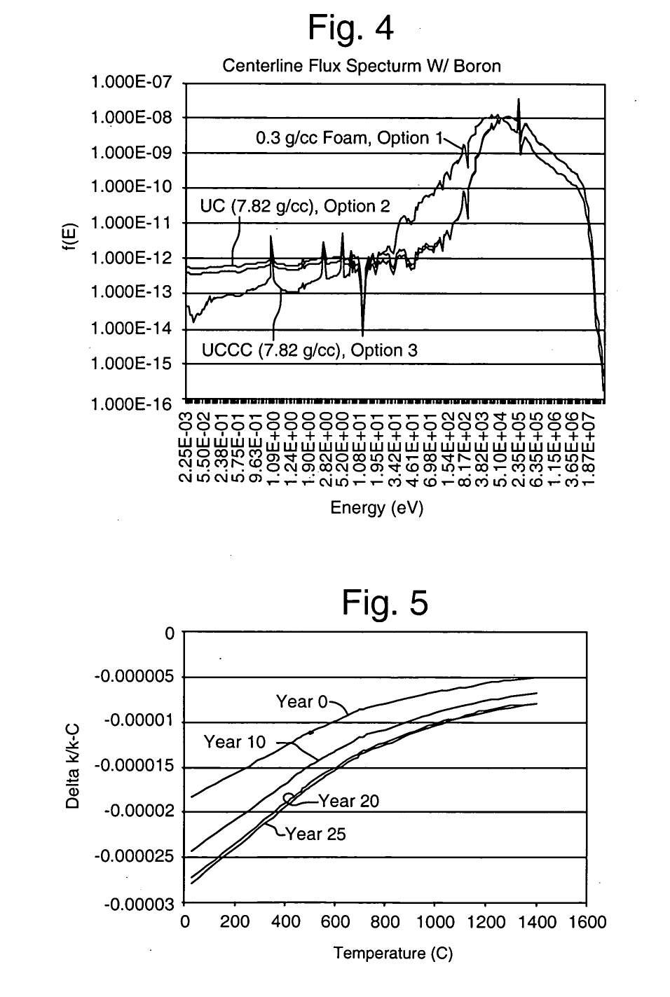

FIG. 4 shows the neutron spectrum for the three embodiments of the reactor 10 at the center of each respective central core 14. Above approximately 10 ev, the neutron spectrum in the second and third embodiments of the reactor 10 is significantly harder than with first embodiment.

FIG. 5 shows the Doppler effect for the first embodiment of the reactor 10 employing graphite foam at various times in a 25-year cycle of operation as a function of temperature. It is seen that the Doppler coefficient becomes more negative with fuel depletion.

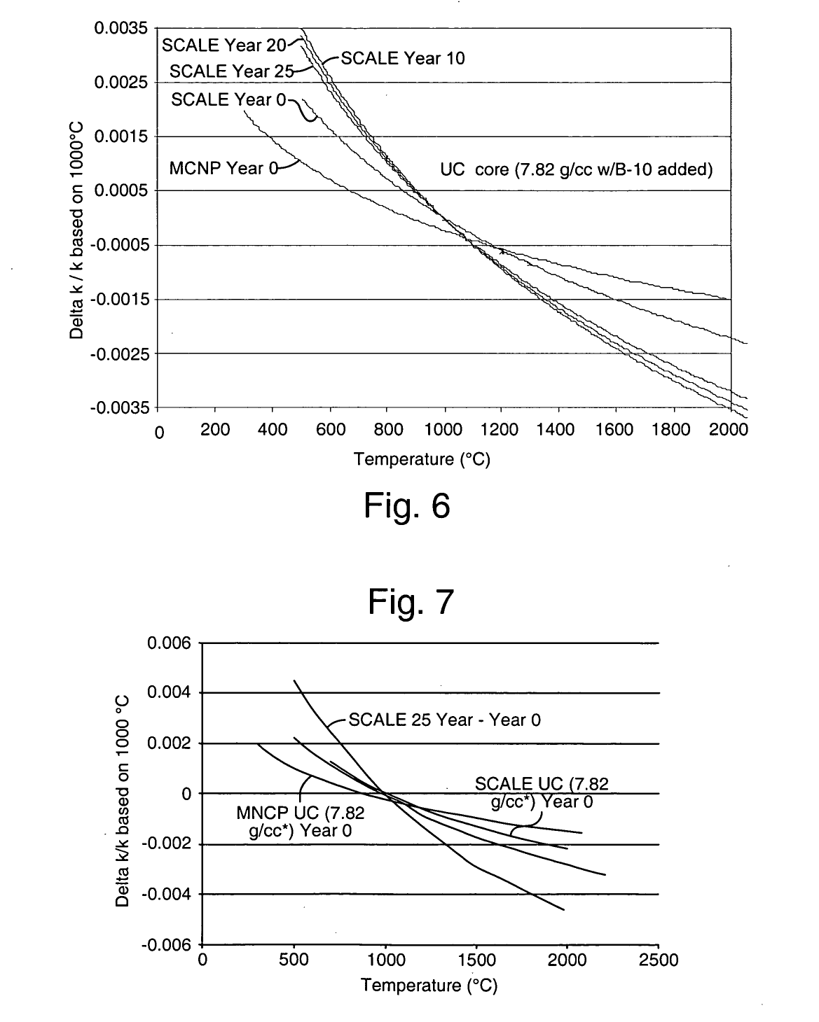

FIG. 6 shows the Doppler reactivity changes for the first embodiment of the reactor 10 from a temperature base of 1000° C. at various times in the fuel cycle. Some differences are noted between results from the SCALE system of codes and from the MCNP calculations. Both sets of results exhibit the same general trend.

FIG. 7 shows the Doppler reactivity changes for the second embodiment of the reactor 10 from a temperature base of 1000° C. at various times in the fuel cycle in both options. Again both sets of data exhibit the same general trend.

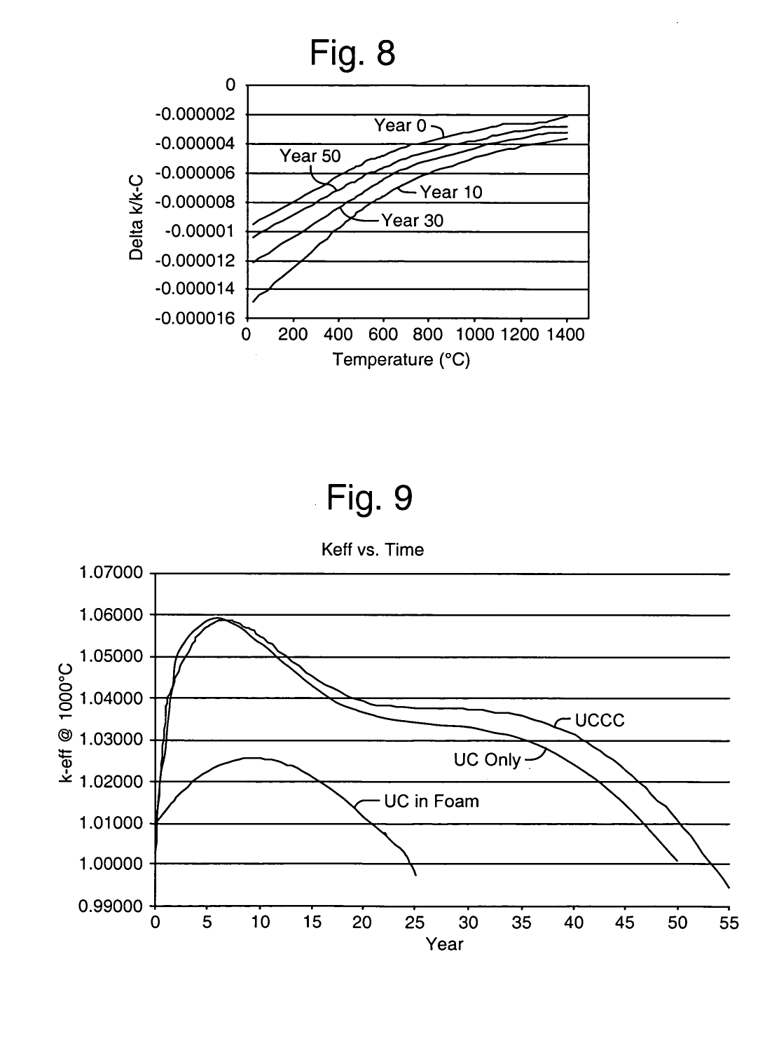

FIG. 8 shows the Doppler coefficients for the third embodiment of the reactor 10.

FIG. 9 shows K_{eff} as a function of year of operation for all three embodiments of the reactor 10. Note that the third embodiment of the reactor 10 can operate for 55 years without ever removing or adding fuel. More particularly, FIG. 9 shows K_{eff} as a function of time for a 50-year period for the second and third embodiments. No fresh fuel was added nor any “old” fuel removed from the core 14, 15 or the reflector 16 during the 50-year fuel depletion calculations. It is seen that the reactor 10 that uses graphite foam yields an increased K_{eff} for the first 10 years which decreases thereafter slowly to 1.000 after 25 years. For embodiments of the reactor 10 that use uranium carbide only, K_{eff} effective increased for the first 6 years and slowly decreases thereafter to 1.0 after 50 years.

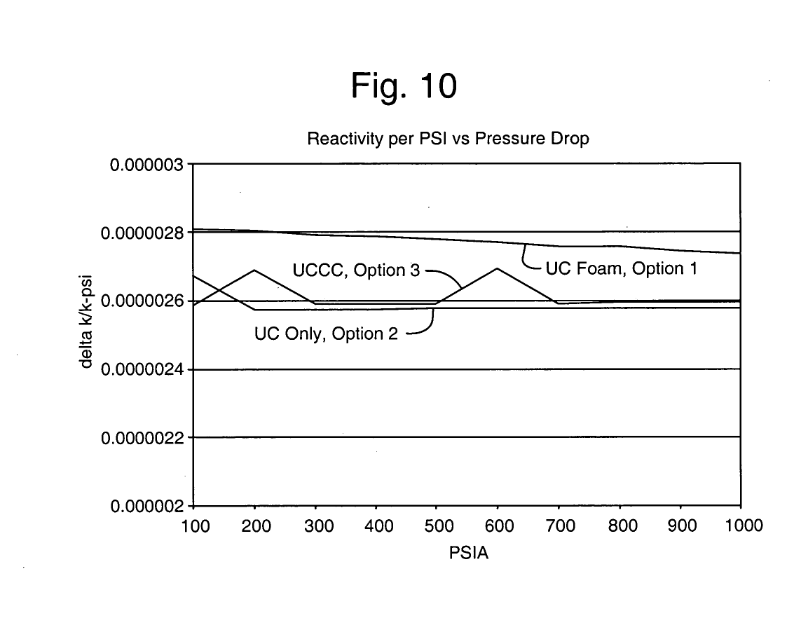

FIG. 10 shows the reactivity coefficient per pounds per square inch of pressure loss in the helium coolant. The value is small but positive. However, the combined effect of Doppler coefficient and pressure loss is always negative. Also, for the first embodiment of the reactor 10 employing graphite foam, the MCNP results are a factor of 5 lower than the results from SCALE.

Thus, it can be seen that the above-described high temperature helium-cooled fast reactors 10 use ceramic material comprising uranium carbide and silicon carbide or uranium carbide and carbon-carbon composite materials. The exemplary reactors 10 operate at about 1000° C. and at a pressure of 68 bars (1000 psi) in a direct gas cycle at an efficiency of approximately 50%. The exemplary reactors 10 also require no fuel addition or removal for more than 50 years.

Thus, improved high temperature helium-cooled fast reactors have been disclosed. It is to be understood that the above-described embodiments are merely illustrative of some of the many specific embodiments that represent applications of the principles discussed above. Clearly, numerous and other arrangements can be readily devised by those skilled in the art without departing from the scope of the invention.

What is claimed is:

1. Reactor apparatus, comprising:
a housing;
a central core disposed in the housing that comprises a plurality of abutting hexagonal blocks of ceramic material that comprise burnable poison, each hexagonal block comprising a plurality of coolant channels disposed therein for transporting coolant therethrough, and wherein outer surfaces of each hexagonal block and surfaces of each coolant channel are coated with a material comprising a containment shell; and
a reflector disposed between the central core and the housing that comprises a plurality of abutting hexagonal blocks of ceramic material, each hexagonal block comprising a plurality of coolant channels disposed therein for transporting coolant therethrough, and wherein outer surfaces of each hexagonal block and surfaces of each coolant channel are coated with a material comprising a containment shell, and wherein inner surfaces of innermost hexagonal blocks of the reflector contact outer surfaces of outermost hexagonal blocks of the central core.

2. The apparatus recited in claim 1 wherein the hexagonal blocks of the central core comprise a graphite foam and uranium carbide matrix.

3. The apparatus recited in claim 2 wherein the containment shell comprises silicon carbide.

4. The apparatus recited in claim 1 wherein the hexagonal blocks of the central core comprise uranium carbide.

5. The apparatus recited in claim 4 wherein the containment shell comprises silicon carbide.

6. The apparatus recited in claim 4 wherein the containment shell comprises carbon-carbon composite material.

7. The apparatus recited in claim 1 wherein the hexagonal blocks of the central core comprise uranium enriched to about 12%.

8. The apparatus recited in claim 1 wherein the reflector comprises natural uranium.

9. The apparatus recited in claim 1 wherein the containment shell has a thickness of about 50 μm.

10. The apparatus recited in claim 1 wherein the central core comprises a central core surrounded by an outer core, and wherein the central and outer cores have burnable poison disposed therein.

11. The apparatus recited in claim 1 wherein the coolant comprises helium.
